(19) United States
(12) Patent Application Publication
(10) Pub. No.: US 2006/0202496 A1
(43) Pub. Date: Sep. 14, 2006

(54) Clamping device with trigger control

(76) Inventor: Lindsay Peter Robin Davis, West End (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/348,101

(22) Filed: Feb. 3, 2006

Related U.S. Application Data
(60) Provisional application No. 60/658,363, filed on Mar. 2, 2005.

(30) Foreign Application Priority Data
Feb. 3, 2005 (AU) 2005900474

(51) Int. Cl. B66C 1/48

(52) U.S. Cl. 294/102.1

(57) ABSTRACT

The clamping device lifts a slab or panel of stone or similar material. The device includes a pair of jaws that engage opposite sides of the slab and a closing mechanism that urges the jaws together in response to the weight of the device and/or the material. A holding mechanism has a first condition that prevents the action of the closing mechanism and a second condition that allows action of the closing mechanism. A control means that changes the condition of the holding mechanism and is remotely operable by a human user through either a wired or wireless connection. The user can thereby control the clamping device without being endangered by proximity to the slab.

### BACKGROUND TO THE INVENTION

This invention relates to clamping devices for use in lifting heavy sheets of material such as panels or slabs, in particular but not only to devices for lifting slabs of stone such as marble or granite.

Sheet materials are often stacked in an almost vertical orientation with each sheet lying on an adjacent sheet for support. Stone slabs of this kind usually weigh several hundred kilograms and can be dangerous. The sheets sometimes overbalance during lifting operations and can crush the workmen who must approach and manually control each operation.

Various clamping devices are used for lifting individual sheets, such as described in WO 96/29273 for example. They typically have two jaws that are biased together by the weight of the device itself and by the weight of the sheet during a lifting operation. A manual trigger mechanism restricts the bias action and is released by a workman once the device is in position to clamp the edge of a slab. The approach by a workman to operate the trigger is the most dangerous part of the operation.

A lifting operation typically requires the workman to lever a slab away from the stack while a clamp is lowered into position on the edge of the slab by a forklift or overhead crane. The workman must then release the trigger, allowing the jaws to close and grip the slab. The jaws tighten when the device is raised and the slab begins to rise from the ground. Once relocated by the forklift the slab is lowered into contact with the ground still in a vertical orientation, reducing the load. The jaws then open and the trigger mechanism is automatically re-engaged.

### SUMMARY OF THE INVENTION

It is an object of the invention to provide an improved clamping device which can be operated without need of direct manual intervention, or at least to provide an alternative to existing devices.

Accordingly the invention may be said to reside in a clamping device for lifting a sheet of material such as a slab, including: a pair of jaws that engage the sheet, a closing mechanism that urges the jaws together in response to the weight of the device and/or the sheet, a holding mechanism having first and second conditions that respectively prevent and allow action of the closing mechanism, and a control means that changes the condition of the holding mechanism and is remotely operable by a human user.

Preferably the holding mechanism is a trigger that latches a lifting pin of the device, and includes a bias member that urges the holding mechanism into the second condition. Preferably the control means includes a solenoid that allows or urges the holding mechanism from the first condition to the second condition.

The control means may be operable by way of either a wired or wireless connection to the human user.

In a further aspect the invention also resides in a method of operating a clamping device such as indicated above.

### LIST OF FIGURES

Preferred embodiments of the invention will be described with respect to the accompanying drawings, of which:

FIGS. 1a, 1b show closed and open positions of a trigger on a clamping device,

FIG. 2 shows more detail of a trigger release mechanism on the clamping device, and

FIGS. 3a, 3b show how the device may be operated on a forklift.

### DESCRIPTION OF PREFERRED EMBODIMENTS

Referring to these drawings it will be appreciated that the invention may be implemented in various ways in a range of different clamping devices. The embodiments described here are given by way of example only.

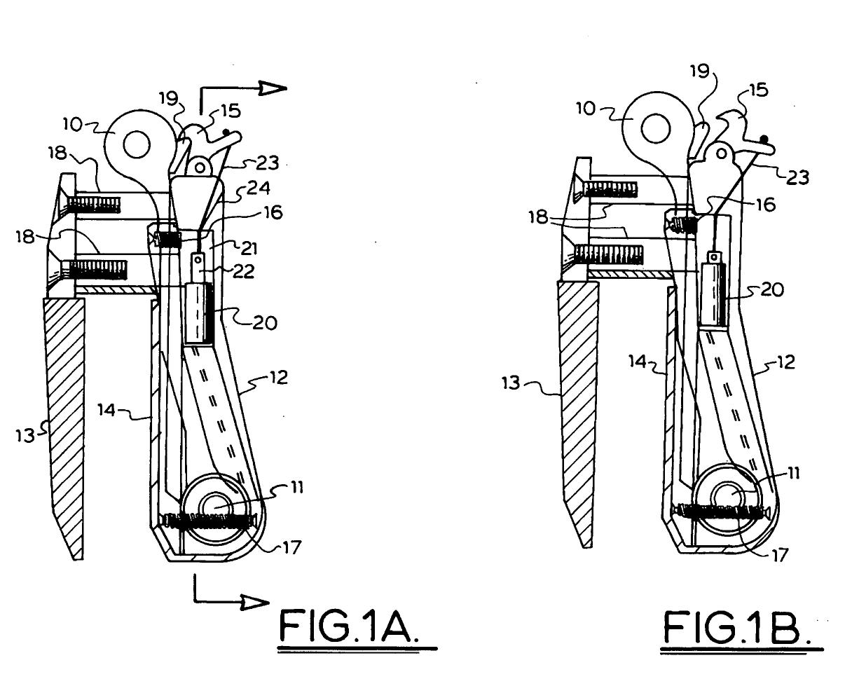

FIGS. 1a and 1b show a clamping device having a lifting pin 10, pressure wheel 11, cam plate 12, a pair of jaws 13, 14 and a trigger 15. These components and other parts of the device are commonly made of steel although a range of materials may be used. The cam plate 12 is inclined towards jaw 14 but is spaced from the jaw by two pairs of springs 16, 17. The jaws are spaced by a pair of arms 18. The pressure wheel is connected to the lifting pin and able to move upwards between an inside surface of the cam plate 12 and an inside surface of jaw 14, against the action of springs 16, 17. This moves the jaws toward each other along arms 18. Trigger 15 has a closed position on lug 19 of the lifting pin, as shown in FIG. 1A, which prevents movement of the lifting pin and the pressure wheel. The trigger has an open position as shown in FIG. 1B, in which lug 19 is released, thereby enabling the lifting pin to move and the jaws to close.

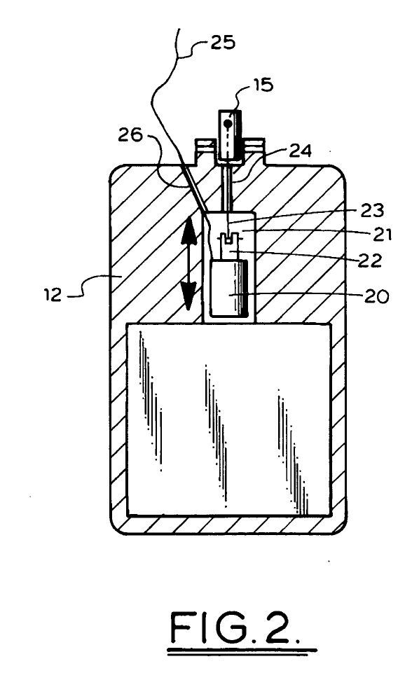

FIG. 2 in conjunction with FIGS. 1a, 1b shows how a trigger release mechanism may be provided in the clamping device. FIG. 2 shows a section AA through the device in FIG. 1A. Trigger 15 is biased by a spring into a normally closed position, as in FIG. 1a. A solenoid 20 is contained by recess 21 on an inside or outside surface of the cam plate 12. Plunger 22 in the solenoid is connected to trigger 15 by a cable 23 that runs in groove 24. In this example, the solenoid is energised from a remote power source along cable 25. A groove 26 may be provided for cable 25. Energising the solenoid withdraws the plunger along with cable 23, and thereby tips the trigger 15 into the open position as in FIG. 1b. In other embodiments the solenoid might be located elsewhere on the clamping device, or energised by a local source of power such as a battery, for example, and operated by a wireless controller.

A clamping device of this kind may used when lifting vertical slabs of heavy material such as marble or granite. The device is suspended by the lifting pin 10 from the boom on a forklift, an overhead crane, or similar vehicle. The trigger 15 is latched on the lifting pin and jaws 13, 14 remain open while the clamp is positioned in relation to the upper edge of a slab. When a lift is about to commence the trigger is released and the jaws close into contact with the slab, initially under the weight of the clamp itself. Operation of the solenoid holds the trigger in the open position until lug 19 on the lifting pin is clear of the trigger. This avoids the need for manual operation of the trigger and the danger that arises in the vicinity of large slabs. As the clamp is raised by the forklift, the weight of the slab off the ground continues to withdraw the lifting pin and tightens the jaws still further. As the slab is lowered onto the ground, the load is reduced and the lifting pin descends within the clamp, so that lug 19 re-engages the trigger.

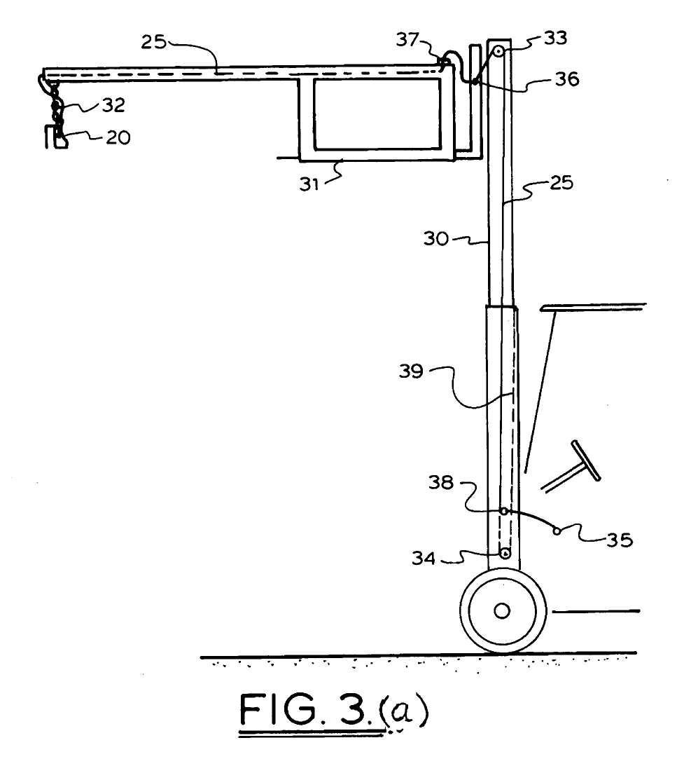

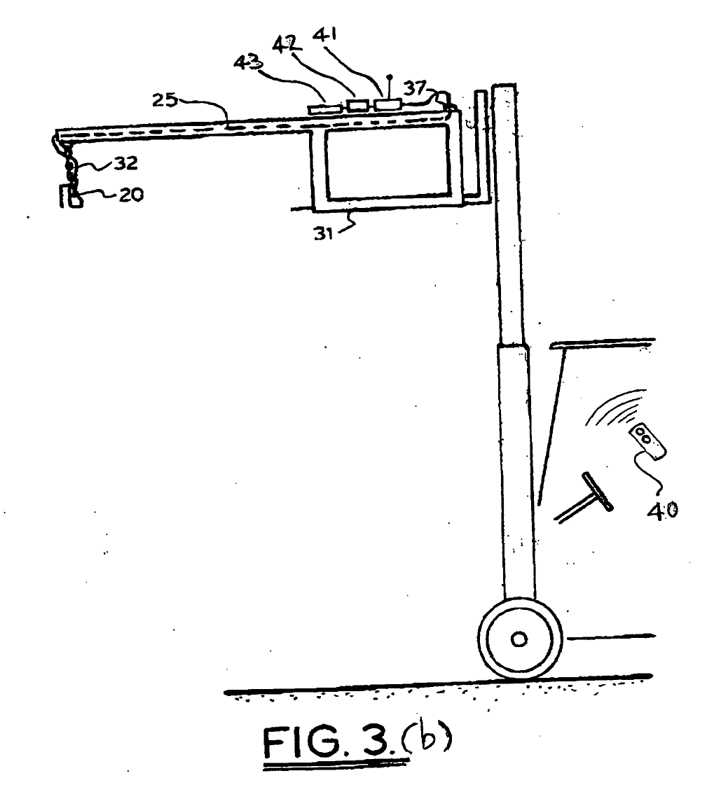

FIGS. 3a, 3b show how the clamping device of FIGS. 1a, 1b and FIG. 2 may be operated in relation to a forklift having a two-stage mast 30 and a boom 31. The clamping device is suspended by a chain 32. Electrical power is supplied to the solenoid 20 along cable 25 which is preferably kept under a light tension, despite the range of movements typically required by the mast. The driver of the forklift operates the clamping device using either wired or wireless control.

In FIG. 1a, the electrical power originates along a wired connection from the main battery of the forklift. Pulley wheel 33 is installed at the top of the mast to carry the cable and a switch 35 is installed in the cab for use by a driver. The cable passes through an aperture or other attachment 36 on the boom and a quick release plug 37 may be provided to allow disconnection between the boom and the mast if required. In this example, the lower end 38 of the cable is attached to a length of flexible cord 39 which passes around an additional pulley wheel 40 at the foot of the mast or on the chassis of the forklift. The length of the flexible cord 39 varies as the mast is raised or lowered, and maintains the cable 25 in approximately constant tension.

In FIG. 3b, electrical power is supplied to the solenoid from a relatively small battery 43 installed near the clamping device, typically on the boom. A controller 40 operated by the driver sends wireless signals to the receiver 41 to control the flow of power to the clamping device. Quick release plug 37 connects the receiver to the cable 25. A programmable timer 42 determines the duration of the operation of the solenoid which in turn determines the length of time that the trigger on the clamping device remains open. The timer may be set for a predetermined interval, typically one to five seconds, or for a variable interval depending on how long the driver manually holds a button on the controller 40.

In operation, a driver of the forklift can control the trigger 15 on the clamping device without need of manual assistance. Operation of the switch 25 or the controller 40 energises the solenoid and releases the trigger when the jaws of the device are required to close. Loading and unloading the device with the weight of the slab then tightens the jaws and resets the trigger respectively.

1. A clamping device for lifting a slab, panel or sheet of material, including:
a pair of jaws that engage opposite sides of the material,
a closing mechanism that urges the jaws together in response to the weight of the device and/or the material,
a holding mechanism having first and second conditions that respectively prevent and allow action of the closing mechanism, and
a control means that changes the condition of the holding mechanism and is remotely operable by a human user.

2. A device according to claim 1 wherein the holding mechanism includes a bias member that urges the holding mechanism into the second condition.

3. A device according to claim 1 wherein the control means includes a solenoid that allows or urges the holding mechanism from the first condition to the second condition.

4. A device according to claim 1 wherein the control means is operable through either a wired or wireless connection.
